(19) United States
(12) Patent Application Publication
(10) Pub. No.: US 2015/0238974 A1
(43) Pub. Date: Aug. 27, 2015

(54) LIQUID DENSITY SEPARATION SYSTEM

(71) Applicant: SEMINIS VEGETABLE SEEDS, INC., St. Louis, MO (US)

(72) Inventors: Kenneth Chen-Ting Wang, Oxnard, CA (US); Juan Alvarez, Oxnard, CA (US)

(21) Appl. No.: 14/605,762

(22) Filed: Jan. 26, 2015

Related U.S. Application Data
(63) Continuation of application No. 12/019,512, filed on Jan. 24, 2008, now abandoned.
(60) Provisional application No. 60/886,480, filed on Jan. 24, 2007.

(51) Int. Cl. B03B 5/36; B03B 11/00; B03B 5/44

(52) U.S. Cl. CPC B03B 5/36; B03B 5/442; B03B 11/00

(57) ABSTRACT

The invention provides a separation system comprising a decanter, a supply tank, a first conduit between the decanter and supply tank, and an overflow reservoir in fluid communication with an upper portion of the decanter. Also provided is a method of separating particles. The method comprises providing a reservoir comprising a plurality of seeds in a liquid; providing an inlet flow of the fluid into the reservoir; adjusting the specific gravity of the liquid so that a first portion of the seeds float near the surface of the liquid and a second portion of the seeds sink near the bottom of the reservoir; providing an outlet flow of the fluid from a location proximal to the top of the reservoir, wherein the outlet flow removes the first portion of the seeds from the reservoir; and recycling the outlet flow of the fluid back to the inlet flow of the fluid. The system and method of the invention are particularly useful for separating seeds based on differences in specific gravity.

This application claims the priority of U.S. Provisional Patent Appl. Ser. No. 60/886,480, filed Jan. 24, 2007, the entire disclosure of which is specifically incorporated herein by reference.

### BACKGROUND OF THE INVENTION

1. Field of the Invention

The present invention relates to liquid density separation systems.

2. Description of Related Art

Liquid density separation (LDS) systems utilize a liquid solution to separate particles, such as plant seeds, based on differences in the specific gravity of individual particles. In typical systems, the specific gravity of the liquid solution is adjusted so that a portion of the particles float near the surface of the liquid solution, while another portion of the particles float in lower regions of the liquid, or sink to the bottom of the liquid.

With respect to plant seeds in particular, LDS systems can be utilized to separate seeds containing fully developed embryos from seeds with no or partially developed embryos. LDS systems may also be utilized to separate hybrid seeds from inbred seed types.

While LDS systems provide many benefits, operation of typical LDS systems is a labor-intensive process that creates potential ergonomic, safety, and environmental issues. For example, in typical LDS systems, workers must transfer the seeds from one container to the next, creating the potential for spills. Due to the large quantities of plant seeds that may need to be separated, as well as the other concerns, it would be beneficial to provide a more efficient LDS system. Such a system could increase capacity, reduce labor requirements, and improve environmental, health, and safety issues. Embodiments of the present invention provide a system and method for efficient liquid density separation of particles such as plant seeds.

### SUMMARY OF THE INVENTION

In one aspect, the invention provides a separation system comprising a decanter; a supply tank; a first conduit between the decanter and supply tank; and an overflow reservoir in fluid communication with an upper portion of the decanter. In certain embodiments, the system is defined as a seed separator system. The system may, in one aspect, further comprise a distribution header disposed within the decanter, wherein the distribution header is in fluid communication with the supply tank. In some aspects, the distribution header extends around the perimeter of the decanter. The distribution header may also comprise a series of nozzles. In additional aspects, the distribution header is comprised of, for example, a PVC pipe, such as an approximately one-inch diameter PVC pipe. Some embodiments of the separation system further comprise a first pump in fluid communication with the first conduit. In further embodiments, the separation system further comprises a separator in fluid communication with the overflow reservoir. Additionally, the system can comprise a first aperture near the top of the decanter. In these embodiments, the decanter can also comprise a second aperture below the first aperture. Further, the decanter can also comprise a third aperture below the second aperture. The decanter can also comprise a plurality of apertures proximal to the top of the decanter.

In additional embodiments of the invention, a supply tank in a system provided herein comprises a mixer. Additionally, the system can further comprise a pre-soak tank, wherein the presoak tank is configured to soak seeds during operation of the separation system. The separation system can also further comprise a separator. The separation system can additionally comprise a dewatering station. In further embodiments, the separation system can comprise a specific gravity meter. In additional embodiments, the separation system can comprise a recirculation tank. Further, the separation system can comprise a filter. In some embodiments of the separation system, the supply tank comprises a first liquid having a first specific gravity and a second liquid having a second specific gravity. In these embodiments, the first liquid can be water and the second liquid can be an aqueous potassium nitrate solution. In additional aspects of the invention, during operation a liquid flows from the first conduit and fills the decanter. In certain of these aspects, the liquid flows out of the decanter and removes a portion of a plurality of seeds that are floating in the liquid.

The invention also provides a method of separating seeds. The method comprises, in one embodiment, providing a reservoir comprising a plurality of seeds in a liquid; providing an inlet flow of a liquid into the reservoir; adjusting the specific gravity of the liquid in the reservoir so that a first portion of the seeds float near the surface of the liquid and a second portion of the seeds sink near the bottom of the reservoir; and providing an outlet flow of the liquid from a location proximal to the top of the reservoir above the location of the second portion of seeds. The outlet flow may be recycled back to the reservoir and/or inlet flow. In this manner seeds of lower density can be separated from higher density seeds. By repeating the procedure and/or adjustment of the specific gravity of the liquid in the reservoir, further separations can be made. For example, the procedure may be repeated at least one, two, three, four, five, six, eight, ten or more times to achieve the desired separation. Lower density seeds may be removed at each selection. The relatively higher density seeds can be retained in the reservoir during the procedure as desired, until the remaining seeds meet the chosen density criteria. The methods provided herein are particularly amenable to large batch sizes. In specific embodiments, the plurality of seeds may be defined as comprising, for example, at least about 500, 1,000, 5,000, 10,000, 15,000 25,000, 50,000, 100,000 or more seeds. The plurality of seeds may comprise seeds from the same species or variety and may be from different species or varieties. The seeds may be of the same species, but differ in genotype. The seeds may be from any species, including, for example, cotton.

In some embodiments, seed separation in accordance with the invention comprises providing a distribution header comprising nozzles proximal to the bottom of the reservoir, wherein the inlet flow of the liquid flows from the nozzles. In some aspects of these embodiments, the distribution header is one inch diameter PVC pipe and the nozzles are approximately 1/16 inch diameter. In other aspects, the nozzles are distributed along the bottom and sides of the distribution header. In other embodiments of these methods, the specific gravity of the liquid is from about 1.0 to about 1.16, including about 1.02, 1.04. 1.08, 1.1, 1.12, and 1.14. The methods can also comprise directing the first portion of seeds to a separator, wherein the separator separates the first portion of seeds from the liquid. These embodiments can further comprise filtering the liquid that has been separated from the first portion of seeds. The invention methods can, in other embodiments, further comprise pre-soaking the seeds before placing the seeds in the reservoir. Additionally, the invention methods can further comprise sending the first portion of seeds to a dewatering station.

### BRIEF DESCRIPTION OF THE DRAWINGS

FIG. 1 is a schematic view of an LDS system in accordance with a first embodiment of the invention;

FIG. 2 is a schematic view of an LDS system in accordance with a second embodiment of the invention;

FIG. 3 is a plan view of a component of an LDS system in accordance with the embodiment of FIG. 2;

FIG. 4 is a section view of the component of FIG. 3; and

FIG. 5 is a schematic view of an LDS system in accordance with a third embodiment of the invention.

### DETAILED DESCRIPTION OF DISCLOSED EMBODIMENTS

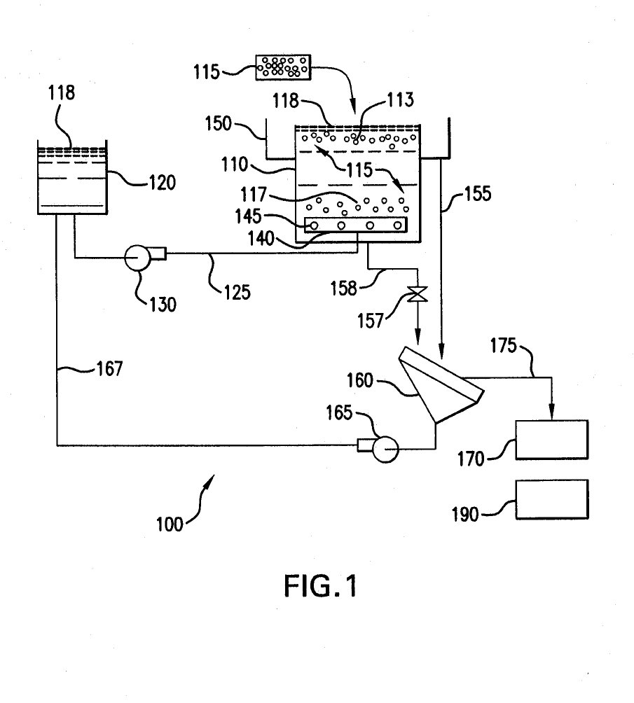

Referring initially to FIG. 1, one embodiment of a liquid density separation (LDS) system provided herein 100 comprises a separation reservoir or decanter 110 in fluid communication with a conduit 125 and a supply tank 120. In the embodiment shown, a pump 130 and a distributor 140 are in fluid communication with conduit 125. The embodiment shown also comprises an overflow reservoir 150 in fluid communication with a separator 160 via conduit 155. In this embodiment, separator 160 is configured to send solid particles to a storage tank 170 and send liquid back to supply tank 120 via pump 165.

During operation of LDS 100, seeds 115 may also be added to decanter 110. In certain embodiments, seeds 115 will comprise individual seeds that have differing specific gravities so that lower specific gravity seeds 113 will float near the top of liquid 118 in decanter 110. In contrast, higher specific gravity seeds 117 will not float near the top of liquid 118 in decanter 110. LDS system 100 may be operated to separate lower specific gravity seeds 113 from higher specific gravity seeds 117 based on differences in the specific gravity of higher specific gravity seeds 117 and lower specific gravity seeds 113 in the manner described below.

In one embodiment, supply tank 120 is partially filled with liquid 118, which is pumped to decanter 110 via pump 130 and conduit 125. In the embodiment shown, conduit 125 terminates at distribution header 140, which comprises a series of nozzles 145 that direct liquid 118 into decanter 110. In certain embodiments, distribution header 140 creates an upward flow of liquid 118 inside of decanter 110. This upward flow can be used to assist in lifting lower specific gravity seeds 113 to the top of liquid 118 in decanter 110.

In the embodiment shown, the level of liquid 118 in decanter 110 is maintained so that liquid 118 flows out of decanter 110 and into overflow reservoir 150. Because lower specific gravity seeds 113 are floating at or near the top of liquid 118 in decanter 110, lower specific gravity seeds 113 will also flow out of decanter 110. In this embodiment, conduit 155 directs liquid 118 and lower specific gravity seeds 113 to a separator 160 that separates lower specific gravity seeds 113 from liquid 118. Lower specific gravity seeds 113 may then be sent to storage tank 170 via conduit 175 while liquid 118 is transferred back to supply tank 120 via pump 165 and conduit 167. After lower specific gravity seeds 113 have been transferred to storage tank 170, storage tank 170 can be removed and replaced with a storage tank 190.

In the embodiment shown, after the lower specific gravity seeds 113 have been removed from decanter 110 and storage tank 170 replaced with storage tank 190, a valve 157 may be opened to allow liquid 118 and higher specific gravity seeds 117 to drain from the lower portion of decanter 110. In this embodiment, a conduit 158 directs liquid 118 and higher specific gravity seeds 117 to separator 160, which can then separate higher specific gravity seeds 11 from liquid 118 and direct higher specific gravity seeds 117 to storage tank 190. In this manner, lower specific gravity seeds 113 and higher specific gravity seeds 117 have been separated from each other and placed into separate storage tanks 170 and 190, respectively.

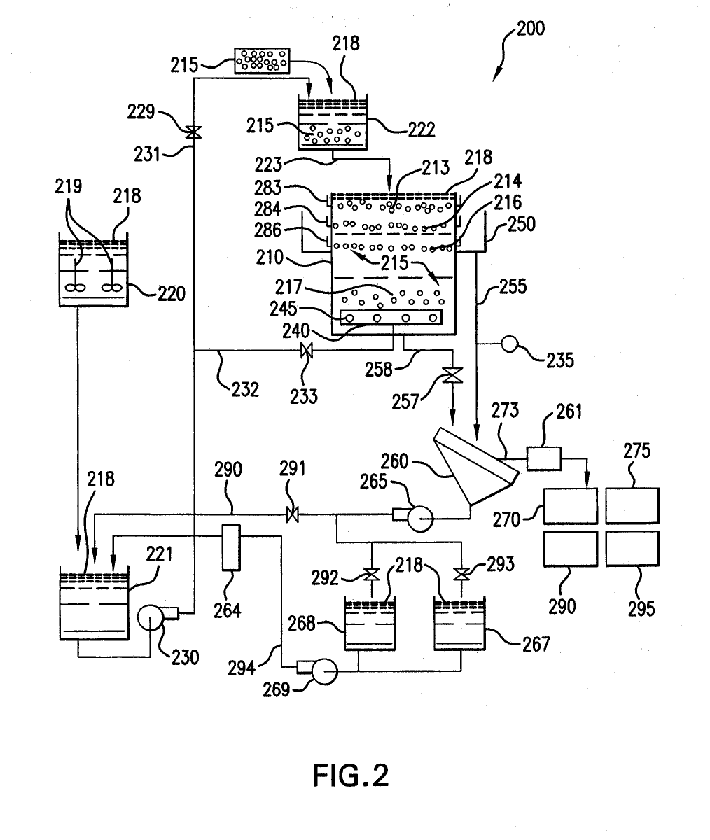

FIG. 2 depicts another embodiment of an LDS system 200 that is operated in a manner similar to LDS system 100 described above. LDS system 200 comprises additional features and components not included in LDS system 100.

The embodiment shown in FIG. 2 comprises a liquid 218 in decanter 210, which is in fluid communication with a supply tank 220, a recirculation tank 221, and a presoak tank 222. The embodiment shown comprises a pump 230 that can pump liquid 218 from recirculation tank 221 through conduit 231 to presoak tank 222. During operation of the embodiment shown, seeds 215 can be added to presoak tank 215. After soaking in presoak tank 222, seeds 215 and liquid 218 flow through conduit 223 and into decanter 210. In this embodiment, conduit 232 branches off from conduit 231 and directs a portion of liquid 218 to a distribution header 240 located in decanter 210. The embodiment shown in FIG. 2 comprises valves 229 and 233 that can be opened or closed to control the amount of flow through conduit 231 and 232. In the embodiment shown, distribution header 240 comprises one inch diameter PVC pipe that extends around the perimeter of decanter 210. In the disclosed embodiment, distribution header 240 also comprises a series of nozzles 245 that are holes of approximately 1/16″ diameter.

During operation of the embodiment shown, liquid 218 exits from nozzles 245 and flows upward in decanter 210. The upward flow of liquid 218 can assist in lifting a portion of seeds 215 that have a lower specific gravity to the top of decanter 210. In certain embodiments, the upward flow of 218 may result in lowering the specific gravity of liquid 218 needed to lift a portion of seeds 215 to a region near the surface of liquid 218. In certain embodiments, seeds 215 may be segregated into different layers depending on their specific gravity. For example, seeds 215 may be separated by specific gravity (from least to greatest) into a top layer of seeds 213, an upper middle layer of seeds 214, a lower middle layer of seeds 216, and a bottom layer of seeds 217. In the embodiment shown, decanter 210 comprises a top door (or aperture) 283, a middle door 284 and a lower door 286.

In the embodiment shown, top door 283, middle door 284 and lower door 286 may be opened during operation to allow a portion of seeds 215 to exit decanter 210. For example, if top door 283 is opened, top layer of seeds 213 will be allowed to flow out of open door 283, into a catch basin 250, through a conduit 255 and onto a separator 260. In the embodiment shown, seeds 213 can be sent from separator 260 to a dewatering station 261. In certain embodiments, dewatering station 261 comprises a rinser, a centrifuge and a dryer (not shown). After exiting dewatering station, seeds 213 can be placed in a storage container 270 via conduit 273.

After top layer of seeds 213 has been removed, middle door 284 can be opened so that seeds 214 may be removed from decanter 210 in the manner described above for seeds 213. In the embodiment shown, seeds 214 are transported to separator 260 and dewatering station 261 to a storage container 275 (which has been moved to replace storage container 270). Similarly, after seeds 214 have been removed, lower door 286 can be opened so that seeds 216 may be removed from decanter 210. In the embodiment shown, seeds 216 are transported to separator 260 and dewatering station 261 to a storage container 290 (which has been moved to replace storage container 275).

In the embodiment shown, pump 230 can be shut down after seeds 213, 214, and 216 have been removed from decanter 210. Valve 257 may then be opened so that seeds 217 may be drained from decanter 218. In the embodiment shown, conduit 258 transports seeds 217 to separator 260, dewatering station 261 and a storage container 295 (which has been moved to replace storage container 290). In the manner described above, seeds 213, 214, 216 and 217 each have different specific gravities and have been placed in separate storage containers 270, 275, 290 and 295, respectively.

During operation of the embodiment shown in FIG. 2, a pump 265 can pump liquid 218 from separator 260 directly back to recirculation tank 221 via conduit 290. If valve 291 is closed and either valve 292 or 293 are open, pump 265 may also be used to pump liquid 218 from separator 260 to either tank 267 or tank 268. In the embodiment shown, pump 269 may then pump liquid 218 through conduit 294 and a filter 264 before liquid 218 is returned to recirculation tank 221. In this embodiment, filter 264 may filter debris (for example portions of broken seeds 215) from liquid 218.

LDS system 200 can be used to separate seeds based on specific gravity for a number of different purposes. In certain embodiments, LDS system 200 can be used to separate seeds (for example, tomato seeds) with lower specific gravity from those with higher specific gravity to improve germination properties. For example, LDS system 200 can separate seeds with no or partially-developed embryos from seeds with fully-developed embryos.

In other embodiments, LDS system 200 may separate seeds (for example, brassica seeds) into multiple categories based on their specific gravity for hybridization purposes. In certain embodiments, a batch of seeds may contain genetic hybrid seeds as well as inbred seeds, and the differences in specific gravity between the hybrid seeds and the inbred seeds may be small. Therefore, it may be difficult to determine what percentage of seeds need to be removed in order to eliminate a desired percentage of the inbred seeds. In certain embodiments, LDS system 200 may be operated with multiple doors 283, 284, and 286 to separate the seeds into different groups of seeds 213, 214, 216 and 217 based on specific gravity. The groups of seeds may then be planted to determine which group of seeds comprise an acceptable percentage of hybrid and inbred seeds. With this information, a determination can be made that seeds of a certain specific gravity (i.e., seeds that float high enough in liquid 218 to be removed when a specific door 283, 284 or 286 is opened) should be removed in future separation processes.

In certain embodiments, decanter 210 is constructed of a transparent material so that an operator can determine where the different layers of seeds 213, 214, 216 and 217 are located. In such embodiments, an operator may be able to estimate the percentage of seeds that will be removed by opening any of doors 283, 284 or 286.

In the embodiment shown in FIG. 2, a specific gravity meter 235 allows an operator to measure the specific gravity of liquid 218, and a supply tank 220 comprises a mixer 219 to mix liquid 218.

In certain embodiments, decanter 210 measures 55 inches wide by 55 inches long by 60 inches tall and is comprised of clear polycarbonate to allow an operator to see the layers of seeds floating in liquid 218. In certain embodiments, presoak tank 222 measures 40 inches wide by 40 inches long by 48 inches tall and is comprised of clear polycarbonate. In certain embodiments, recirculation tank 221 is a 500 gallon tank (model number 500 CB30VDT) manufactured by Snyder Industries, measuring 86 inches in diameter by 46 inches high and made of high density polyethylene (HDPE) with a 1.9 specific gravity. In certain embodiments, supply tank 220 is a 150 gallon tank (model number 150PCO) manufactured by Snyder Industries, measuring 30 inches in diameter by 44 inches high and made of high density polyethylene (HDPE) with a 1.9 specific gravity. In certain embodiments, separator 260 is a SWECO model number XS48S88 measuring 68 inches wide by 47 inches long by 47 inches high driven by a 2.5 horsepower 1200 rpm, 480V X3P (3 phase) TENV motion generator. In certain embodiments, storage tank 267 and storage tank 268 are each 1,000 gallon tanks (model number 1000 CB30VDT) manufactured by Snyder Industries, measuring 86 inches in diameter by 68 inches high and made of high density polyethylene (HDPE) with a 1.9 specific gravity. In certain embodiments, filter 264 is a Hayward model number FLT4202 filter, 10 inch diameter by 48 inch height, with 2 inch NPT inlet and outlet connections, a 25 pound solid collection and 7.8 gallon liquid retention. In certain embodiments, pump 230 is an FTI model number AC8SJS, driven by a 20 horsepower motor at 3500 rpm and pumping 132 gallons per minute (gpm). In certain embodiments, pumps 265 and 269 are FTI model number AC6SJS pumps, driven by 5 horsepower motors at 3500 rpm and pumping 132 gpm. In certain embodiments, a mixer 219 in supply tank 220 comprises 2 McMaster-Carr air-powered mixers with single six inch propellers. The above specifications are illustrative, non-limiting embodiments provided for purpose of example.

In certain embodiments, liquid 218 is water. In other embodiments, liquid 218 has additional chemicals, such as potassium nitrate (KNO₃) or sugar, added to water to raise the specific gravity of liquid 218. In a particular embodiment, potassium nitrate is added to water to raise the specific gravity of liquid 218 to between about 1.0 and about 1.16, including, for example, about 1.02, 1.04, 1.06, 1.08, 1.1, 1.12, 1.14 and 1.16. In still other embodiments, LDS system 200 may be used to separate particles other than seeds.

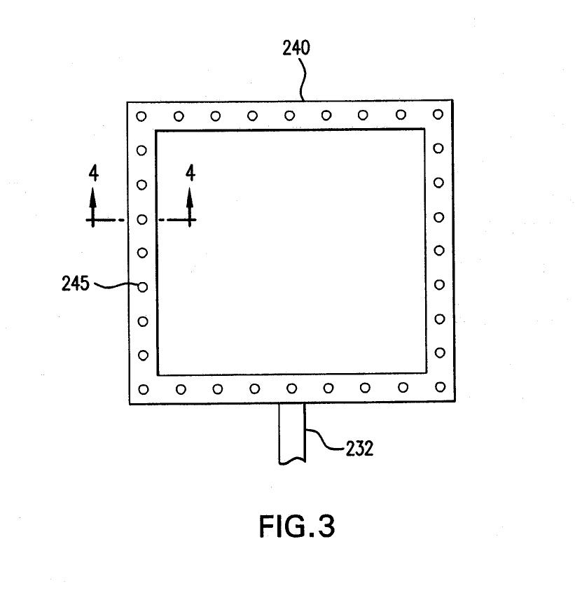

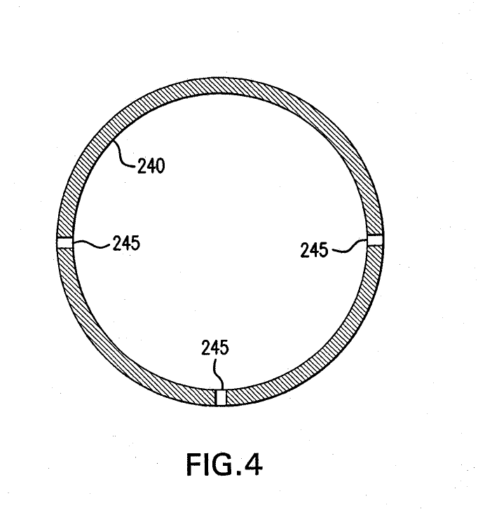

Referring now to FIGS. 3 and 4, a bottom and section view of one non-limiting embodiment of distribution header 240 is shown. In this embodiment, nozzles 245 are drilled along the bottom and sides of header 240. In other embodiments, distribution header 240 may be a different configuration, and nozzles 245 may be in different locations.

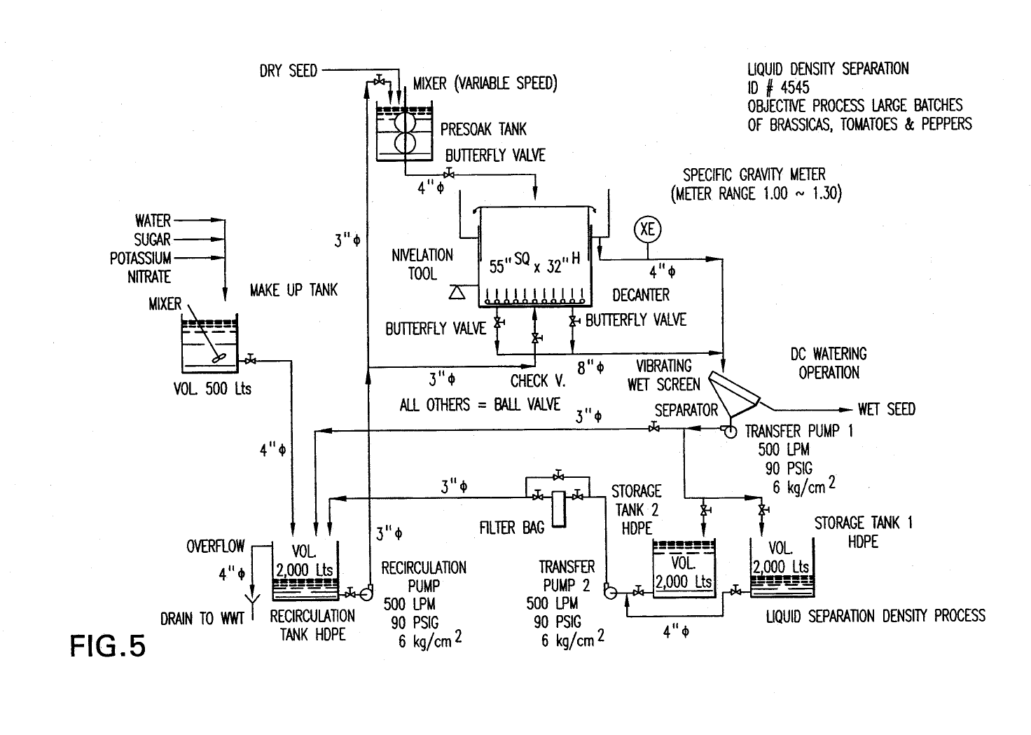

FIG. 5 is a schematic sketch of an LDS system in accordance with an illustrative, non-limiting embodiment of the invention.

The above-described embodiments of the present invention are intended to be examples only. Alterations, modifications and variations may be effected to the particular embodiments by those of skill in the art without departing from the scope of the invention, which is defined solely by the claims appended hereto. For example, additional components such as valves may be used to isolate equipment such as pumps, filters, tanks, etc. In addition, components such as pumps, filters, tanks, distribution headers, mixers, separators, dewatering stations, meters, etc. may be added or deleted from the embodiments disclosed without departing from the scope of the invention. The drawings are not to scale, and certain features may have been enlarged for clarification purposes.

What is claimed is:

1. A seed separation system comprising:
a decanter;
a supply tank;
a first conduit between the decanter and supply tank; and
an overflow reservoir in fluid communication with an upper portion of the decanter.

2. The seed separation system of claim 1, further comprising a distribution header disposed within the decanter, wherein the distribution header is in fluid communication with the supply tank.

3. The seed separation system of claim 2, wherein the distribution header extends around the perimeter of the decanter.

4. The seed separation system of claim 2, wherein the distribution header comprises a series of nozzles.

5. The seed separation system of claim 2, wherein the distribution header is comprised of one-inch diameter PVC pipe.

6. The seed separation system of claim 1, further comprising a first pump in fluid communication with the first conduit.

7. The seed separation system of claim 1, further comprising a separator in fluid communication with the overflow reservoir.

8. The seed separation system of claim 1 wherein the decanter comprises a first aperture near the top of the decanter.

9. The seed separation system of claim 8 wherein the decanter comprises a second aperture below the first aperture.

10. The seed separation system of claim 9, wherein the decanter comprises a third aperture below the second aperture.

11. The seed separation system of claim 1, wherein the decanter comprises a plurality of apertures proximal to the top of the decanter.

12. The seed separation system of claim 1, wherein the supply tank comprises a mixer.

13. The seed separation system of claim 1, further comprising a pre-soak tank, wherein the presoak tank is configured to soak seeds during operation of the separation system.

14. The seed separation system of claim 1, further comprising a separator.

15. The seed separation system of claim 1, further comprising a dewatering station.

16. The seed separation system of claim 1, further comprising a specific gravity meter.

17. The seed separation system of claim 1, further comprising a recirculation tank.

18. The seed separation system of claim 1, further comprising a filter.

19. The seed separation system of claim 1, wherein the supply tank comprises a first liquid having a first specific gravity and a second liquid having a second specific gravity.

20. The seed separation system of claim 19, wherein the first liquid is water and the second liquid is an aqueous potassium nitrate solution.

21. The seed separation system of claim 1, wherein during operation a liquid flows from the first conduit and fills the decanter.

22. The seed separation system of claim 21, wherein the liquid flows out of the decanter and removes a portion of a plurality of seeds that are floating in the liquid.

23. A method of separating seeds, the method comprising:
a) providing a reservoir comprising a plurality of seeds in a liquid;
b) providing an inlet flow of liquid into the reservoir;
c) adjusting the specific gravity of the liquid so that a first portion of the seeds float near the surface of the liquid relative to a second portion of the seeds that sink near the bottom of the reservoir; and
d) providing an outlet flow of the liquid from a location proximal to the top of the reservoir, wherein the outlet flow removes the first portion of the seeds from the reservoir

24. The method of claim 23 further comprising providing a distribution header comprising nozzles proximal to the bottom of the reservoir, wherein the inlet flow of the liquid flows from the nozzles.

25. The method of claim 24 wherein the distribution header is one inch diameter PVC pipe and the nozzles are approximately 1/16 inch diameter.

26. The method of claim 24 wherein the nozzles are distributed along the bottom and sides of the distribution header.

27. The method of claim 23 wherein the specific gravity of the liquid is between about 1.0 and about 1.16.

28. The method of claim 23 wherein the specific gravity of the liquid is between 1.0 and 1.12.

29. The method of claim 23 further comprising directing the first portion of seeds to a separator, wherein the separator separates the first portion of seeds from the liquid.

30. The method of claim 29, further comprising filtering the liquid that has been separated from the first portion of seeds.

31. The method of claim 23, further comprising pre-soaking the seeds before placing the seeds in the reservoir.

32. The method of claim 23, further comprising sending the first portion of seeds to a dewatering station.

33. The method of claim 23, further comprising recycling the outlet flow of the liquid back to the inlet flow of the liquid.

34. The method of claim 23, further comprising repeating steps c) and d) at least once to remove a further portion of seeds from the reservoir.

35. The method of claim 34, comprising changing the specific gravity of the liquid before repeating steps c) and d).

36. The method of claim 23, wherein the step of adjusting the specific gravity of the liquid comprises adjusting an inlet flow to the reservoir of a first liquid having a first specific gravity and a second liquid having a second specific gravity.

37. The method of claim 36, wherein the first liquid is water and the second liquid is an aqueous potassium nitrate solution.
